(19) United States
(12) Patent Application Publication
(10) Pub. No.: US 2003/0211925 A1
(43) Pub. Date: Nov. 13, 2003

(54) Supporting, fastening and reinforcing member for a plane tool used in a waste stripping station of a diecutting press

(75) Inventor: Jean-Pierre Steiner, Crissier (CH)

Correspondence Address: OSTROLENK FABER GERB & SOFFEN, 1180 AVENUE OF THE AMERICAS, NEW YORK, NY, 100368403

(73) Assignee: Bobst S.A.

(21) Appl. No.: 10/403,953

(22) Filed: Mar. 28, 2003

(30) Foreign Application Priority Data
Mar. 28, 2002 (CH) 2002 0531/02

(51) Int. Cl. B31B 49/00

(52) U.S. Cl. 493/373

(57) ABSTRACT

Supporting, fastening and reinforcing members for a plane tool with apertures which is used in a waste stripping station of a diecutting press. The reinforcing members are interfitted into a stripping board of the stripping station easily without the use of any mechanical parts, such as rivets, screws, bolts or adhesives and serve to rigidify and strengthen the stripping board against breaking or bending during the stripping operation.

### BACKGROUND OF THE INVENTION

The present invention relates to a supporting, fastening and reinforcing member for a plane tool used in a waste stripping station of a diecutting press, mainly for use in the packaging industry.

The processing of paper, cardboard sheets or plastic matter for obtaining the various edge outlines, internal cutouts, folding lines and the like in blanks of which boxes are made comprise a series of operations in which the initial flat blanks for the boxes and the like are cut from large sheets. The sheets are held by of their front edges by a variety of grips assembled along a movable transverse bar. The sheets are thus conveyed into a diecutting and embossing station, and then into a stripping station in which waste resulting from diecutting is removed from the sheets.

A large number of blanks, or outlines of boxes, can typically be diecut from a single, large sheet. These blanks are typically flat in a preliminary form and, after being folded and glued, result in the contemplated or desired packaging boxes. The outlines of these blanks are diecut by adhering to certain cutting rules in the platen press, and the various folding lines of these blanks are formed with creasing or scoring tools during the same operation. To prevent the sheet from breaking apart after diecutting, the cutting scheme leaves notches at various junctions of adjacent diecut parts of the sheet. These blanks stay weakly held together by means of bridges of material, called nicks, which are deliberately saved from being diecut during this process.

Although the blanks are very carefully laid out on the large sheet, in order not to waste raw material and produce the largest number of blanks from a single sheet, it is virtually impossible to avoid producing waste as a result of the diecutting process. This waste comprises the outline of the sheet and the internal intermediate parts which occupy the spaces between the blanks themselves. The entirety of the waste is stripped from the large sheet in the stripping station, for example, by pinching the waste material between pairs of stripping pins that pull them down and makes them fall into a container or onto a stripping belt.

The stripping station generally comprises an upper tool movable vertically up and down and equipped with ejectors, a stripping board with shaped apertures which are located to register with the portions of the sheet being die cut, and usually a lower tool which operates together with the upper tool to strip the waste from the sheet. The sheets successively stop on the stripping board, so that the waste may be removed.

However, sometimes the lower tool is not used, in which case the waste is ejected from the sheets only by means of the ejectors of the upper tool which push the waste downwards. Such a stripping station or technique is referred to in the art as “dynamic” stripping.

At high speed, the stripping board is disadvantageously submitted to strong vertical pressures or forces due to the fact that the waste, not being pinched prior to stripping, must be still held partially on the edges of the apertures intended for the stripping, in order to allow the waste to first bend downwards, so as to break all of the nicks connecting it to the sheet in the stripping station. Without this technique, a few nicks are likely not to be broken in the stripping station and this would then allow the waste to hang in the aperture of the stripping board to inevitably jam the operation of the machine at the stripping station. It is for this reason that the prior art has provided the solution of pinching the waste between the upper tool and the lower tool to enable perfect stripping at a high speed without any likelihood of machine jams.

Generally, the upper tool has a size similar to that of the sheet and typically comprises a wooden board with apertures or a framework provided with several rods on which are assembled stripping pins for removing the waste from the sheet by pushing it downward through the apertures of the stripping board. Sometimes, the upper tool also comprises pressing devices, made up, for example, of small foam rubber that are deployed for simply maintaining the blanks of the sheet against the upper side of the stripping board. The lower tool in this instance comprises telescopic stripping pins arranged opposite to those of the upper tool. This prior art arrangement enables precise pinching of the waste and the stripping of it from the sheet through the stripping board, at a time when the movable upper tool moves downwards, all this taking place prior to the sheet being removed from the stripping station by a gripper bar which seizes the front edge of the sheet. Such a prior art stripping station is illustrated and described in more detail in patent document CH689974.

The present invention is directed to and provides beneficial results for a stripping board of a prior art stripping station. The upper and lower tools, as well as the stripping board, are generally fastened to or held by a supporting frame that can be easily removed from the stripping station by horizontal sliding. The stripping board which is intended to support only the blanks of the sheet, while enabling the stripping of the waste comprises variously shaped edges and outlines which are instrumental in the overall manufacturing of the blanks. In other words, the stripping boards must not interfere with the stripping operations being performed on the sheet. Thus, the stripping board cannot be directly fastened within its supporting frame at any of its upstream, downstream or lateral edges. Instead, it requires to be assembled on crossbars or longitudinal metal bars of steady and relatively lengthy construction in order to be properly placed and maintained within the supporting frame, supported only at its edges or lateral ends. These load bearing crossbars generally have a rectangular cross-section which are oriented to resist bending, i.e., with the larger dimension of the crossbar being oriented perpendicularly to the plane of the stripping board. In the prior art, such crossbars are typically mounted against the lower side of the stripping board by various screwed blocks that must engage both the crossbars and the stripping board. The prior art construction is described in patent document CH575294, and specifically, in FIGS. 2 and 3 thereof.

However, the prior art construction suffers from certain drawbacks, including the fact that the crossbars require a multiplicity of small spare parts, e.g., various squares and screws for their fastening, all of which requires relatively long manufacturing steps in drilling, fitting and assembly tasks. Moreover, the prior art requires large spaces on the surface of the stripping board, usually occupied by the various fastening squares. Disadvantageously, the shapes of the boxes that need to be processed pose a conflict with the placement of these various blocks and mounting hardware on the stripping board, which disturbs the diecutting marking between the apertures of the stripping board. This is an intolerable situation, because the apertures in no way can be blocked, even partially, by mounting hardware.

As noted, the apertures of the stripping board must directly correspond to the shape of the blanks and their layout on the sheet being diecut. It frequently occurs that it is impossible to avoid having relatively significant material wastage. However, the more material that is diecut from the large sheet, the more apertures in the stripping board, which results in a stripping board that is structurally fragile. It is for this reason that it is known to reinforce the stripping board against bending by the addition of the aforementioned reinforcing bars mounted against the lower side thereof, in a manner similar to the bars which support the overall structure thereof. To assure the utility of these reinforcing bars, they are often designed and constructed so that they are as long as the board itself, and at the same time, shaped in such a way as to avoid having to construct them of several pieces, as that would increase their susceptibility to bending. Nonetheless, to enable these reinforcing bars to be properly mounted on the surface of the stripping board, it is often necessary to bend them several times, i.e., in a shape of an irregular line, so as to enable the reinforcing bars to avoid the apertures. This very careful designing renders the realization of a stripping board more difficult, as well as more expensive. Moreover, this stripping board design cannot be standardized, as it requires specific design and manufacturing effort to be configured for each specific stripping board. These considerations, taken together with the requirement for various fastening hardware, such as screws, bolts and blocks, constitutes a further drawback of the prior art. This is even further complicated by the eventual need to disassemble the stripping board, resulting in an overall high cost of production.

In one prior art attempt to solve the foregoing problems, it has been suggested to replace the usually metallic bearing parts, as well as the reinforcing bars, with bars or crossbars that are constructed of less expensive material, such as wood. However, wood being a material less rigid than metal, requires, in turn, the use of larger and thicker reinforcing bars. This increased size produces the inconvenience of needing more space on the surface of the stripping board and renders the task of designing these various bars to avoid the apertures even more difficult or more susceptible to produce even greater waste. Moreover, the ends of the bearing crossbars are typically comprised of sharper, i.e., thinner edges, in order to allow them to engage with the various gripping devices that are associated with the overall framework of the manufacturing apparatus. The thinner and sharper profile of the ends of these crossbars, when made of wood, has a negative effect, because they have a more delicate and fragile construction and thus require much greater attention during the use of the stripping board. Lastly, because these wooden parts are more susceptible to wear, tests have shown that they become rather quickly prone to ever increasing vibration when in continuous use.

### SUMMARY OF THE INVENTION

In general, the objective of the present invention is to provide a plane tool, such as a stripping board processing station which follows a platen press, that is provided with load bearing, fastening and reinforcing members that are free of the above-mentioned drawbacks of the prior art.

It is a further object of the invention to produce the aforementioned members in a manner that they are easily manufacturable, and made of preferably less expensive materials having greater strength.

A still further object of the invention is to provide these reinforcing members in regular and standardized shapes so that these crossbars may be readily used and ready for use without requiring any specific adaptation to various different embodiments of stripping boards.

According to the invention, these members are preferably mountable on the stripping board without any screwing parts, or additional fastening elements, while maintaining a strong attachment between these reinforcing members and the stripping board, by a readily executed step that does not require lengthy labor or the use of any additional adhesive material, not even quick hardening glues.

Moreover, in accordance with the aims of the invention, these members are designed in a manner that they can be implemented in an extremely reduced time period and at a substantially reduced cost, such that they need not be saved or stored if there is no immediate intent to use the same stripping board and associated reinforcing members with subsequent production work.

Generally, in accordance with the present invention, the reinforcing bars for the stripping board of the present invention comprise elements that allow these crossbars to be sturdily and fixedly fastened against one of the sides of the stripping board without the use of any mechanical elements other than the reinforcing members, that is, without the use of any rivets or screws or bolts or adhesive or the like. Preferably, these reinforcing members comprise geometric projections that snap into the stripping board and rigidify it.

Other features and advantages of the present invention will become apparent from the following description of the invention which refers to the accompanying drawings.

### BRIEF DESCRIPTION OF THE DRAWINGS

FIG. 1 is a top view of a sheet on which the outlines of a plurality of stripped blanks are drawn.

FIG. 2 is a lower view of a stripping board with apertures on which the sheet of FIG. 1 stops for the removal of the waste.

FIG. 3 is an elevation view of a bearing bar according to the invention, mounted against the lower surface of the stripping board represented in a vertical cross-section.

FIG. 4 is a partial elevation view of another embodiment of a bearing bar, or preferentially, of a reinforcing bar used to rigidify the stripping board that is fragile due to its many apertures.

FIG. 5 depicts the female part of another embodiment of the device of the invention, mainly used as a gripping means for maintaining the stripping board within its bearing framework.

FIG. 6 depicts, on a crown-shaped portion, a plurality of male parts of the embodiment illustrated on FIG. 5, intended snap into the female part to simply and definitively fasten the latter to the stripping board.

### DETAILED DESCRIPTION OF PREFERRED EMBODIMENTS OF THE INVENTION

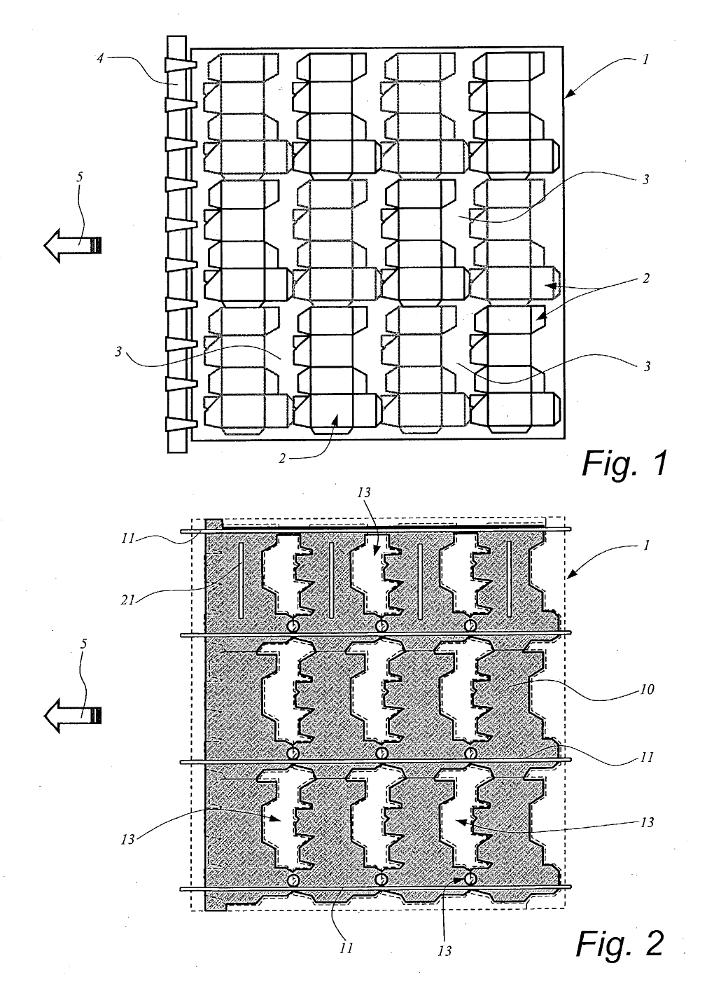

FIG. 1 shows a large sheet 1 on which there are defined a large plurality of blanks 2 and waste areas 3 and the lines of the demarcation between them, as would result from a diecutting process through the use of a platen press which precedes a diecutting station. FIG. 1 shows twelve blanks 2 or outlines of cardboard boxes arranged side by side on sheet 1, representing their ultimate design forms. For better understanding, these blanks are drawn in different types of lines. One set of lines delineates the outlines of the final box, such as it was diecut, whereas internal features corresponding to folding lines that have been marked or scored by following various creasing or scoring rules during diecutting are illustrated by differently shaped lines. To enable the large sheet of FIG. 1 to travel from the diecutting station to the waste stripping station, the sheet 1 is moved by being held at its front edges by means of a gripper bar 4, traveling in the direction of arrow 5.

FIG. 2 illustrates the bottom view of the plane tool of the stripping station, constituting a stripping board 10, the geometry of which is related to and corresponds to the blanks 2 of sheet 1. Illustrated relative to the stripping board 10 is the sheet 1, as it was diecut according to the outlines of each of the blanks 2. The circumferential periphery of the sheet 1, as well as the diecutting lines of the blanks are illustrated by dotted lines, whereas the stripping board 10 is denoted by hatched lines, in order to better distinguish its outlines.

After passing through the diecutting station, the sheet 1 is brought to a stop above the stripping board 10 in a manner whereby the blanks 2 are in perfect register with the edges of the apertures 13 of the board 10. Thus, the entirety of the waste 3 of the sheet 1 is seated above the open workspaces, i.e., apertures, of the stripping board 10, or outside the stripping board if that waste is located at the side edges of the sheet. With the assistance of the upper and lower tools (not shown) of the stripping station, the entirety of the waste 3 can be removed from the sheet 1 with a single operation, either through punching through the apertures of the wooden board 10 or within its circumference. Once this action is completed, the sheet 1 leaves the stripping station, moving in the direction of arrow 5, without the blanks being dislocated or disassembled from the sheet, owing to various nicks, which are too small to be illustrated in the figure, that still connect all of the blanks to each other.

In FIG. 2, bearing bars 11 are mounted against one of the sides of the stripping board 10, usually against its lower side, with the double objective of firstly supporting the stripping board while it is conveyed and introduced into and within the stripping station, and secondly, to enable gripping mechanisms to seize and rigidly fasten the board in the stripping station, usually by means of a horizontal supporting frame that can be moved into the device like a drawer. The overall stripping station and the supporting frame have not been shown, because they do not relate directly to the subject matter of the invention and they would only complicate the understanding of the specific contribution of the present invention.

With further reference to FIG. 2, between the two upper bearing bars 11, there are provided reinforcing bars 21 that extend in a direction different than that of the bars 21 and which serve to lend additional rigidity to the wooden board having the apertures 13. The bearing bars 11 and the reinforcing bars 21 which constitute the focus of the present invention are described in more detail below, relative to the remaining figures.

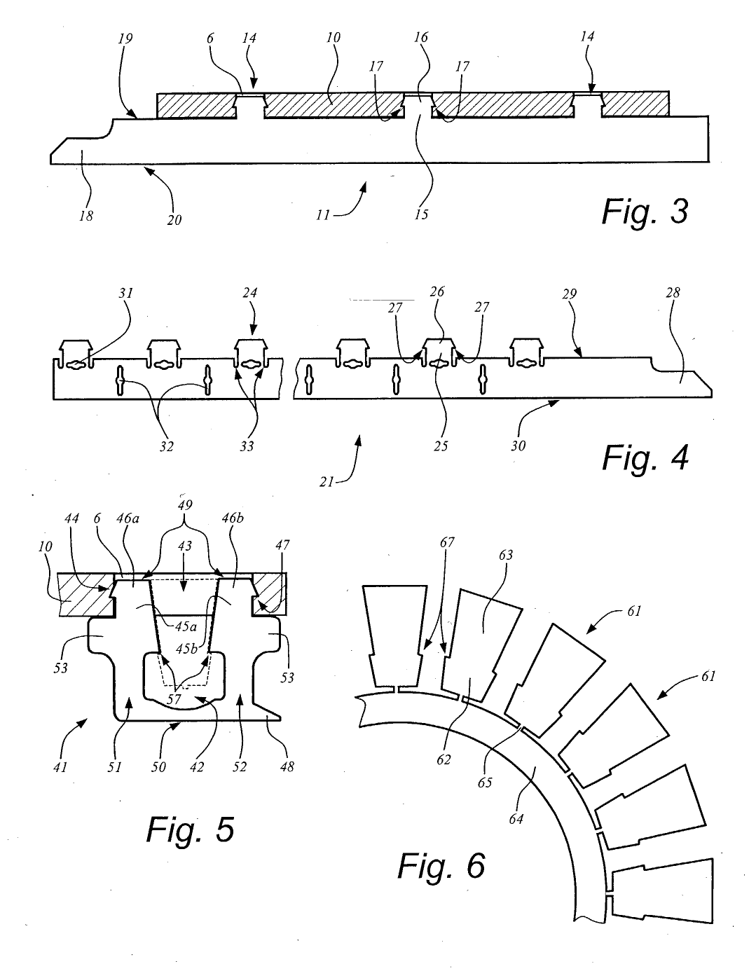

FIG. 3 is a cross-sectional view of FIG. 2 showing one of the bearing bars 11 as it is mounted against the lower side of the stripping board 10, whose cross-sectional shape is shown with cross-hatched lines. This bearing bar 11 has a laminated, planer and flat geometry defining an upper edge 19 and lower edge 20. In order to be mounted securely and fixedly into the stripping board without any mechanical parts, such as rivets, screws, bolts, adhesives and the like, this bearing bar 11 is provided, along its upper edge 19, with a plurality of fastening heads 14, each of which comprises a shaft portion 15 that terminates in an upper part 16 that has at least one laterally projecting part 17, preferably two, which project from vertical edges of the shaft 15. These projecting parts are of such length that the end part 16 is effectively entirely penetrated into the thickness of the stripping board 10, once the bearing part is correctly and fully inserted. As shown in FIGS. 3 and 4, end parts 16 are trapezoidal-shaped. However, it is readily apparent to one of skill in the art that these end parts could also be round, rectangular, triangular or any other shape.

To assure that the bearing bar 11 can be introduced into the stripping board 10 without damaging the board, the cutout 6 in the lower side of the board are pre-formed so as to fully accommodate the fastening heads 14. These cutouts or apertures 6 can be formed or machined by a laser, while the apertures 13 are similarly formed in the stripping board. Given that the stripping board is generally made of wood, the laser machining does not cause any particular inconvenience and is advantageously faster, precise and of obviously common use for the processing of the stripping boards usually used in the field of the present invention.

Thus, to allow assembly of the bearing bars on the stripping board 10, a pressure is exerted on the bars by hitting its lower edge 20 with a wooden hammer, until the upper edge 19 is completely laid against the lower side of the stripping board 10. Owing to the shape and transfer projection of the part 17, they engage the sidewalls of the cutout 6, so as to prevent or at least retard the bearing bars from being withdrawn, thereby rigidly and fixedly fastening these members in the board 10. The upper side of the fastening head preferably reaches slightly below the upper level of the upper side of the stripping board with a gap between. However, it is also possible to allow the fastening head to lightly touch the upper side of the stripping board. The edge 18, which has a smaller thickness, projects to the side of the blank and main body of the board 10 and provides a region by which the bar can be gripped by a clamping device which is provided for the stripping board, with at least one of the ends 18 of the bar being formed and shaped for this purpose.

An alternate embodiment for the bearing bar 11 of FIG. 3 is shown in the form of a reinforcing bar 21 in FIG. 4, which is similarly used to rigidify the stripping board, whose structure might have been weakened due to the apertures formed therein. This reinforcing bar 21 also presents a flat laminated geometry defining an upper edge 29 and a lower edge 30. Here, on the reinforcing bar 21 is shown, with the intention that it will be snap fitted into a stripping board 10 (not shown) that is located relative to is, as shown in FIG. 3. The fastening ends 24 of the reinforcing bar 21 are identical to the fastening ends 14 of the bearing bar 11 and are identically used. Thus, each of the heads 24 also has a vertical trunk 25, an ending part 26 and, preferably, two laterally projecting parts 27 arranged on the lower ends of the ending part 26.

A main difference between the bearing bars 11 and 21 is that the latter comprises elongated horizontal apertures 31 and similar vertically extending apertures 32 and grooved-shaped notches machined to the bottom of each trunk 25 on each side, as shown. The elongated horizontal aperture 31 are machined at the bottom of the trunk 25, slightly below the level of the upper edge 29. Owing to these elongated horizontal apertures, it is easier to break the fastening end 21 by means of a common gripper. These apertures located slightly below the upper edge 29, as well as the vertical grooves 33 flanking the trunk 25, enable breaking the fastening head 24 without preventing the joining of the reinforcing bar against the underside of the stripping board 10 at the time that it is assembled.

The elongated vertical apertures 32 also facilitate the sectioning of the reinforcing bar 21 at selected lines or points. These apertures are regularly spaced and arranged between the fastening heads 24. They are advantageously centered in the width of the reinforcing bar and intended to divide the reinforcing bar in several sections. As illustrated in FIG. 2, it is generally necessary to divide a reinforcing bar in several sections in order to have them arranged between two bearing bars 11, or between apertures 13 of the stripping board without the apertures being blocked. By judicious location of these reinforcing bars, and according to the shape and the layout of the blanks 2 on the sheet 1, the sections of the reinforcing bars can be of variable lengths. It is also quite advantageous to easily divide the reinforcing bar into sections of various lengths according to one's needs, depending on the application. Owing to the fact that the spacing of the fastening heads is irregular, it is also easier to know where the aperture 6 will have to be spared, while enabling the travel or movement of the fastening heads in the stripping board 10. These apertures or cutouts 6 can thus be machined at the same time as those intended for the bearing bars 11 and thus, at the same time as the complete machining of the whole stripping board is attended to. To also enable the use of the reinforcing bars as bearing bars, the reinforcing bars 21 are also equipped with at least one end 28 shaped like the corresponding ends 18 of the bearing bars 11. It is also obvious that an ending section of the reinforcing bars can either be used for its reinforcing action or for the function of gripping of the stripping board during its securement into the machine, via the ends 18 and 28.

Depending on the location, and sometimes due to the unusual shape of the blanks 2 on the sheet 1, it may not be possible to arrange bearing bars 11 that extend over the entire length of the stripping board or to have a sufficient number of them installed. It may also happen that even the smallest end of the reinforcing bar is still too long and cannot be arranged where it was previously intended to be on the stripping board for acting and providing the gripping function. To address this problem, a further embodiment of the device of the invention is described as comprising two units fitting one into the other as shown FIGS. 5 and 6.

FIG. 5 illustrates a claw 41 which constitutes the female part of a fastening member mainly used as a gripping means for maintaining and reinforcing the stripping board 10. The claw 41 similarly provides a flat laminated geometry with an upper edge 49 and a lower edge 50. It comprises fastening head 44 split or divided in two ending parts 46a and 46b through a broad and first trapezoidal-shaped aperture 43. Other than for its trapezoidal-shaped aperture 43, the fastening head 44 is identical to the fastening heads 14 and 24 previously described. Thus, each ending part 46a and 46b overlaps a respective section of a trunk 45a, 45b, while forming a projecting part 47 on each side of the fastening head 44. This fastening head is also intended to immovably sink into the aperture or cutout 6 provided in the stripping board 10, as shown in FIG. 5. Below and flanking the cutout 6, the stripping board is also supported on two small brackets 53 forming a base for the claw when it is assembled in the stripping board 10.

The trapezoidal-shaped aperture 43, which preferably divides the fastening head 44 into two symmetrical parts, leads to a second aperture 42, arranged in the lower part of the claw 41, resulting on each side in a sharp angle 57. These two parts 51, 52 are joined at their lower ends by the lower edge 50 that comprises, at least at one end of its ends, a member 48. This member 48 constitutes, just like the ends 18 and 28 of the bars previously described, the gripping structure that interacts with the fastening device of the stripping board intended to be used in the machine. Both apertures 42 and 43 can provide an advantageous elasticity or resiliency to the parts 51, 52.

In order to rigidify the connection of the claw 41 in the stripping board, it may be advantageous to insert a corner, or clip 61 shown in dotted lines in FIG. 5, through the trapezoidal aperture 43. To this end, FIG. 6 shows a plurality of clips 61 arranged on a crown portion 64, which constitutes the male part intended to fit into the claw 43. Each one of these clips is connected to the crown, or to the crown portion 64, by a thin nick of matter 65 so that it can be easily removed manually.

Each clip is made of two parts, an upper part 63 and a lower part 62. The upper part 63 is intended to fit into the trapezoidal aperture 43 of the claw 41 and the lower part 62 to simply fit into the second aperture 42 while stopping against the angular part 57 at the junction of the two apertures 42 and 43. To this end, the upper part 63 of the clip 61 is similarly trapezoidal-shaped, like the aperture 43. The lower part 62 is also trapezoidal in shape. The lower part 62 constitutes the head of the clip 61 and looks like, shapewise and functionally, the fastening heads 14, 24 or 44 previously described. Thus, the lower part shows two projecting parts 67, constituted by assembling parts 62 and 63.

Once the clip 61 is introduced into the claw, these projecting parts 67 precisely position, maintain and block the claw 41 in its final position by assuring that it is supported on the sharp angles 57 of the claw 41. During its introduction into the claw, the clip acts on the spacing of the two parts 51, 52, thus fixedly maintaining this claw in its position in the stripping board 10. Aside from providing a very strong structure, this fastening mechanism advantageously does not need much space on the surface of the stripping board. It is also very simple and therefore inexpensive and able to easily and rapidly be mounted without needing any additional hardware elements or labor.

It is worth mentioning that all of the members 11, 21, 41, 61 are preferably manufactured by laser diecutting, but could also be processed by another inexpensive process, such as stamping, for example. All these members are preferably made of metal, steel or aluminum, but the use of metal is not mandated. The profile of these members is of a rectangular cross-section, but could have different cross-sections in order to decrease the mass, weight and size of these members, while maintaining a sufficient rigidity that resists bending. Advantageously, the thickness of the reinforcing members of the present invention occupies only a very small space on the stripping board, increasing the possibility for its positioning between two blank apertures, even those situated very near one another. Moreover, due to their low production costs, the reinforcing bars of the present invention can be constituted as disposable elements that do not require any disassembling for later use on another stripping board. It is also worth mentioning that the fastening device of the claw by means of a clip could also be part of the fastening heads 14 and 24 to fasten the bearing bar 11 and the reinforcing bar 21 against the stripping board 10.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. An apparatus comprising:
a plane tool having a substantially plane body with apertures through which waste is punched through, in a waste stripping station of a diecutting press, the plane tool having an upper side and a lower side; and
at least one reinforcing member;
wherein the at least one reinforcing member and the plane tool are structured to enable the reinforcing member to be rigidly fastened against one of the sides of the plane tool without the use of any further fastening element other than the at least one reinforcing member and the body of the plane tool being intercoupled.

2. The apparatus of claim 1, in which the at least one reinforcing member comprises a gripping section that extends away from the plane tool, by which the plane tool and the gripping member can be gripped for maneuvering the same in a diecutting press.

3. The apparatus of claim 1, in which the at least one reinforcing member includes a plurality of fastening heads that project from an upper surface of the at least one reinforcing member, the fastening heads are structured to be fixedly inserted into corresponding cutouts provided in the body of the plane tool.

4. The apparatus of claim 3, wherein at least a plurality of the fastening ends are each vertically split into two parts, separated by a respective aperture and including a clip that is insertable into the respective aperture to create a force that enables the fastening heads to tightly grip the body of the plane tool.

5. The apparatus of claim 3, including further apertures defined in the at least one reinforcing member in locations that enable the member to be broken up into two or more pieces.

6. The apparatus of claim 5, in which the further apertures include elongate, horizontally extending apertures provided at a lower end of the fastening heads, and including elongate, vertically extending apertures provided between the fastening heads.

7. The apparatus of claim 6, in which the fastening heads and the elongate vertical apertures are regularly spaced.

8. The apparatus of claim 4, including further apertures defined in the at least one reinforcing member in locations that enable the member to be broken up into two or more pieces.

9. The apparatus of claim 8, in which the further apertures include elongate, horizontally extending apertures provided at a lower end of the fastening heads, and including elongate vertically extending apertures provided between the fastening heads.

10. The apparatus of claim 9, in which the fastening heads and the elongate vertical apertures are regularly spaced.

11. The apparatus of claim 2, in which the at least one reinforcing member has a rectangularly-shaped cross-section.

12. The apparatus of claim 11, in which the at least one member is constructed of metal.

13. The apparatus of claim 2, in which the at least one reinforcing member has a body that defines an upper edge and a lower edge.

14. The apparatus of claim 3, including a plurality of the at least one reinforcing member.

15. The apparatus of claim 14, in which at least two of the plurality of reinforcing members comprise bearing bars that extend across the body of the plane tool.

16. The apparatus of claim 14, in which at least two of the plurality of reinforcing members comprise reinforcing bars which do not extend the full length or width of the body of the plane tool.

17. The apparatus of claim 3, in which the plane tool is a stripping board.
